(19) United States
(12) Patent Application Publication
(10) Pub. No.: US 2024/0049864 A1
(43) Pub. Date: Feb. 15, 2024

(54) COVER FOR COSMETIC PRODUCT PACKAGING DEVICE

(71) Applicant: GUERLAIN, Paris (FR)

(72) Inventor: Sana HADDAD MARCHON, Paris (FR)

(73) Assignee: GUERLAIN, Paris (FR)

(21) Appl. No.: 18/267,679

(22) PCT Filed: Dec. 14, 2021
(86) PCT No.: PCT/FR2021/052329

§ 371 Date: Jun. 15, 2023

(30) Foreign Application Priority Data
Dec. 16, 2020 (FR) FR2013395

(51) Int. Cl. A45D 34/04; A45D 40/00

(52) U.S. Cl. CPC A45D 34/04; A45D 40/00; A45D 2034/007

(57) ABSTRACT

A cover for a cosmetic product packaging device, suitable for attachment to a packaging casing, which comprises: a hollow body, the hollow body comprising first snap-fit reliefs; and a decorative part comprising at least one face intended to be oriented away from the packaging casing and having a decoration, and second snap-fit reliefs. The decorative part is fixed to the hollow body so as to close off an opening of the hollow body, by snap-fitting of the first and second snap-fit reliefs. The snap-fitting of the first and second snap-fit reliefs can be disassembled without damaging the hollow body or the decorative part.

### TECHNICAL FIELD

This disclosure relates to the field of cosmetic product packaging devices.

### PRIOR ART

Users are particularly sensitive to the aesthetics of cosmetic product packaging devices. However, users are looking for a personalized offering, particularly personalizable aesthetics of packaging devices. Users also want to be able to adapt the personalization of their cosmetic product containers to their desires, over the lifetime of the cosmetic product packaging device. Users therefore want the possibility of removing one personalization element in order to replace it with another, without having to buy a new cosmetic product packaging device.

One object of the present invention is therefore to provide an easily personalizable cover for a cosmetic product device, without compromising the aesthetics of the cover in question.

In the field of beverage containers, which is distinctly remote from the field of cosmetic products, it is known to attach a personalization means on a cap by means of a screw, as described in application US 2010/0187196 A1.

Application US 2012/0138563 A1, which also lies within the field of beverage containers, proposes attaching a personalization element to a cap, in order to avoid confusion between the containers of two different owners. The personalization element can take the form of a plate inserted into a corresponding slot at the top of the cap. According to another embodiment provided in that document, the personalization element takes the form of a flexible covering element, unrolled onto the cap.

These solutions do not provide a degree of aesthetics suitable for the technical field of cosmetic product packaging devices.

### SUMMARY

This disclosure improves the situation.

This disclosure proposes a cover for a packaging device for at least one cosmetic product, the cover being suitable for attachment on a packaging casing for a cosmetic product, the cover comprising:
a hollow body extending primarily in a longitudinal direction, comprising a first longitudinal end defining a first opening and intended to be oriented towards the casing of the packaging device, and a second longitudinal end defining an opening, opposite to the first longitudinal end, the hollow body comprising at least one first snap-fit relief, and
a decorative part, the decorative part comprising at least one face intended to be oriented in a direction opposite to the packaging casing and having a decoration, and at least one second snap-fit relief, the decorative part being fixed to the hollow body so as to close off the second opening of the hollow body, by snap-fitting of the at least one first and at least one second snap-fit reliefs, it being possible to disassemble the snap-fitting of the at least one first and at least one second snap-fit reliefs without damaging the hollow body or the decorative part.

According to preferred embodiments, the cover for packaging device may have one or more of the following features, alone or in combination:
the hollow body comprises a shroud defining an internal cavity, and an insert fixed inside the shroud;
the insert has the general shape of a sleeve extending in the longitudinal direction between a first longitudinal end of the insert and a second longitudinal end of the insert, the first longitudinal end of the insert being intended to be oriented towards the first longitudinal end of the hollow body or forming the first longitudinal end of the hollow body, the second longitudinal end of the insert preferably being solid, with, again preferably, at least one through-opening in the longitudinal direction;
the shroud is fixed to the insert by snap-fitting of at least one third snap-fit relief of the shroud with at least one fourth snap-fit relief of the insert, the at least one third snap-fit relief being on an inner face of the shroud, the at least one fourth snap-fit relief preferably being on an outer surface of the insert;
the insert has a means for fixing the cover to the casing of the packaging device, in particular at least one relief for fixing the cover on the casing, in particular at least one snap-fit relief, a threading, or a diameter allowing an adjusted or even a tightly fitting assembly;
the at least one first snap-fit relief is formed by the shroud;
the at least one first snap-fit relief is formed by the insert;
the at least one first snap-fit relief is formed on an outer face of the insert;
the at least one first snap-fit relief is formed by at least one bead, the at least one second snap-fit relief being formed by at least one resiliently deformable tab extending from a face of the decorative part that is opposite to the at least one face having a decoration;
the at least one face having a decoration, of the decorative part, is substantially planar;
the at least one face having a decoration, of the decorative part, is flush with the second end of the hollow body;
the decorative part comprises a decorative plate and a support plate for the decorative plate, the decorative plate being fixed, in particular glued, to the support plate;
the cover comprises a clearance between the decorative part and the second end of the hollow body, the clearance preferably being less than or equal to 1 mm, more preferably less than or equal to 0.5 mm, even more preferably less than or equal to 0.2 mm;
each first snap-fit relief comprises a first surface in contact with a second surface of an associated second snap-fit relief, each first or second surface extending in a plane which forms an angle with the longitudinal direction, the angle preferably being greater than or equal to 30°, more preferably greater than or equal to 40°, and/or less than or equal to 60°, more preferably less than or equal to 50°;
the at least one first snap-fit relief and the at least one second snap-fit relief are shaped to allow disassembly of the decorative part from the hollow body, by pushing on one among the decorative part and the hollow body in the longitudinal direction, the force of the push preferably being between 10 N and 50 N;
the decoration comprises at least one among:
   a color, in particular other than the color of the hollow body or of the shroud, when there is such,
   a pattern,
   at least one disc made of a material or imitating the appearance of a material,
   a trademark, in particular a logo, and
   a recessed or protruding relief;
the cover is a cap;
the hollow body is integral with a rod, an applicator member being arranged at the end of the rod that is opposite to the hollow body; and
the decorative part comprises a guiding relief on a face opposite to the at least one face having a decoration, received in a complementary housing in the hollow body, in particular in the shroud or the insert, when there is such.

According to another aspect, a packaging device for at least one cosmetic product is described, comprising a casing defining a volume for receiving at least one cosmetic product, and a cover as described above in all its combinations, fixed on the casing.

The casing may in particular be a bottle with a neck, preferably provided with a pump, the cover being a cap suitable for fixing to the neck of the bottle.

Alternatively, the casing may be a lipstick body, receiving a lipstick mechanism.

According to another aspect, a tool is described for removing a decorative part from a cover as described above in all its combinations, from the hollow body of the cover, the tool comprising a relief suitable for being received in the hollow body of the cover so as to be in contact with a face of the decorative part, opposite to the at least one face having a decoration, and for allowing a push force to be applied on the decorative part.

Preferably, the tool comprises one or more of the following features, taken alone or in combination:
the tool further comprises a housing for receiving the cover, the relief of the tool projecting from a bottom of the housing;
the second longitudinal end of the insert being solid with at least one through-opening in the longitudinal direction, the relief extends in a longitudinal direction, a longitudinal end of the relief of the tool presenting at least one tab having a position and dimensions suitable for coming into contact with the face of the decorative part that is opposite to the at least one face having a decoration, through the at least one through-opening in the insert and in order to allow a push to be exerted on the face of the decorative part that is opposite to the at least one face having a decoration, as long as the hollow body of the cover is not in contact with the bottom of the housing, when there is such;
the height of the tabs, measured in the longitudinal direction, is such that the tabs push on the decorative part over a relative travel of the hollow body with respect to the tool that is at least equal to the height of the first snap-fit reliefs;
the relief of the tool has a cylindrical rod suitable for traversing all or part of the hollow body of the cover; and
the tool is shaped to allow positioning the cover on the tool in a finite number of angular positions.

According to yet another aspect, an assembly is described of a cover for a cosmetic product packaging device, as described above in all its combinations, and a tool, as described above in all its combinations, that is suitable for allowing the removal of the decorative part from the hollow body.

Finally, a method is described for removing a decorative part from a cover as described above in all its combinations, by means of a tool as described above in all its combinations, the method comprising the steps of:
placing the cover in position on the tool;
exerting a relative push force on the cover in the direction of the tool, along the longitudinal direction.

### BRIEF DESCRIPTION OF DRAWINGS

Other features, details, and advantages will become apparent upon reading the detailed description below, and upon analyzing the appended drawings, in which:

FIG. 1 shows an example of a packaging device for perfume.

FIG. 2 is an exploded view of the packaging device for perfume of FIG. 1.

FIG. 3 is an exploded view of the cap of the packaging device of FIGS. 1 and 2.

FIG. 4 is a longitudinal section view of the insert of the cap of FIG. 3.

FIG. 5 is a section view of the support plate of a decorative part of the cap of FIG. 3.

FIG. 6 is a perspective view of the lower face of the support plate of FIG. 5.

FIG. 7 is a section view, along a first section plane VII-VII, of a portion of the packaging device of FIGS. 1 and 2.

FIG. 8 is a section view along a second section plane VIII-VIII, of a portion of the packaging device of FIGS. 1 and 2.

FIG. 9 shows an enlargement of a detail in FIG. 8.

FIG. 10 shows a section view of a tool that can be used to remove a decorative part from the cap of FIG. 3.

FIG. 11 shows a perspective view of an assembly formed of the cap equipped with a decorative part of FIG. 3 and of the tool of FIG. 10, suitable for using to remove the decorative part from the cap.

FIG. 12 illustrates, in a section view, a first step in removing the decorative part from the cap of FIG. 3, with the tool of FIG. 10.

FIG. 13 illustrates, in a section view in the same section plane as in FIG. 12, a subsequent step in removing the decorative part from the cap of FIG. 3, using the tool of FIG. 10.

### DESCRIPTION OF EMBODIMENTS

In the remainder of the description, elements that are identical or have identical functions bear the same reference number. For conciseness in this description, elements that are identical in multiple examples are not described in detail for each of these examples within the framework of the detailed description. On the contrary, the description below first and foremost details the differences between the various examples.

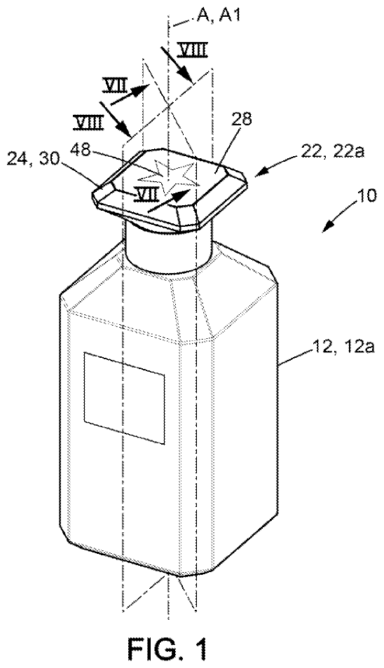

FIG. 1 illustrates an example of a cosmetic product packaging device 10. Here, packaging device 10 comprises a casing 12 in the form of a bottle 12a. Bottle 12a contains a liquid cosmetic product, for example a perfume or an eau de toilette.

Bottle 12a extends primarily in a longitudinal direction, in this case the direction of an axis A. In the following, axis A is referred to as “axis A of bottle 12a”. Bottle 12a is for example rotationally symmetrical around axis A of bottle 12a, or even fully rotationally symmetrical around axis A of bottle 12a.

Bottle 12a here comprises a bottle body 14, forming a neck 16. At the end of neck 16, bottle 12a comprises a ferrule 17 for fixing a body 18 of a pump device 19 on bottle body 14, in particular on neck 16 of bottle 12a. Ferrule 17 is for example screwed onto neck 16 of bottle 12a. Pump device 19 also comprises a button 20 that is movable in translation relative to pump body 18 in order to actuate pump device 19. A covering skirt 21 covers ferrule 17. The function of covering skirt 21 is essentially aesthetic.

Packaging device 10 also comprises a cover 22. Here, cover 22 takes the form of a cap 22a.

As can be seen in the figures, cap 22a has a rotationally symmetrical shape about an axis A1 of cap 22a, corresponding to axis A of bottle 12a when cap 22a is fixed on bottle 12a.

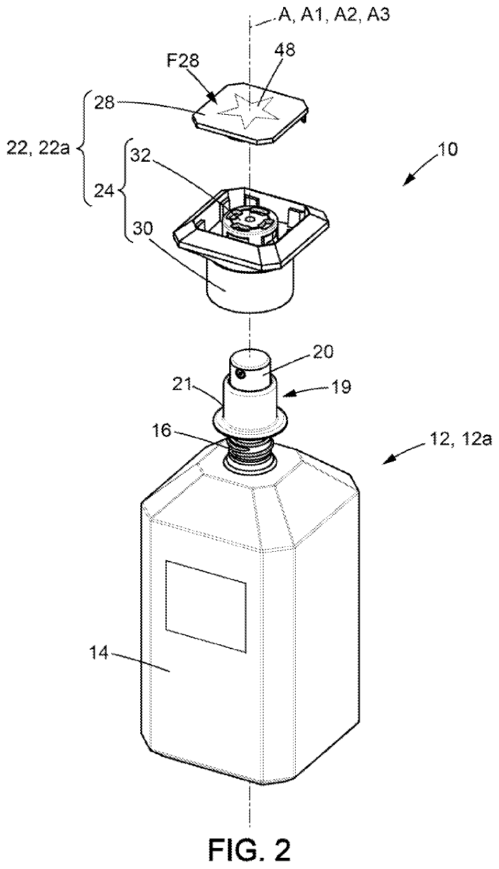

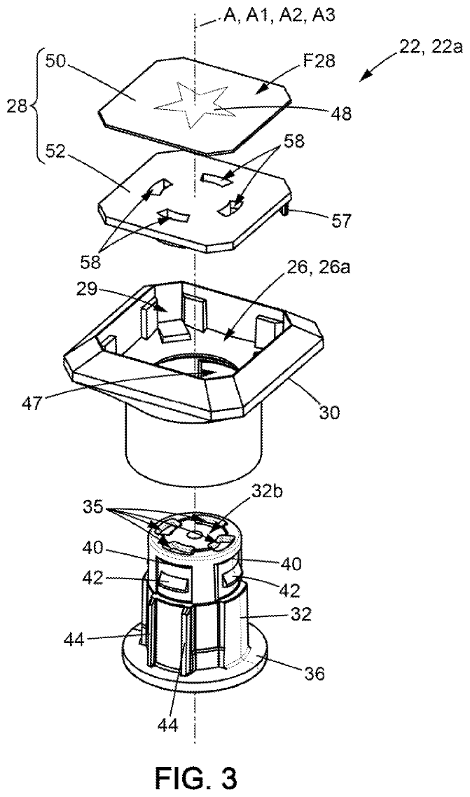

As can be seen in FIGS. 2 and 3, for example, cap 22a here comprises a hollow body 24, defining an internal cavity 26 which is open at an upper end of the hollow body, and a decorative part 28 at least partially closing off internal cavity 26.

In the illustrated example, hollow body 24 comprises a shroud 30, defining internal cavity 26, and an insert 32 fixed inside shroud 30 in internal cavity 26.

The function of shroud 30 is essentially a covering function. Shroud 30 has a general shape which is rotationally symmetrical around axis A1 of cap 22a.

Internal cavity 26 in shroud 30 can be divided into two parts:
the lower part is suitable for essentially receiving covering skirt 21 surrounding the ferrule 17 fixing pump body 18 to neck 16 of bottle 12a. This lower part is for example cylindrical, with a substantially circular cross-section;
the upper part forms a housing 26a which is open at the upper end of hollow body 24, suitable for receiving the upper end of button 20 of pump device 19 and the upper end of insert 32. Here, housing 26a has a square cross-section with chamfered corners. At each chamfered corner is formed a groove 29, extending parallel to axis A1 of cap 22a.

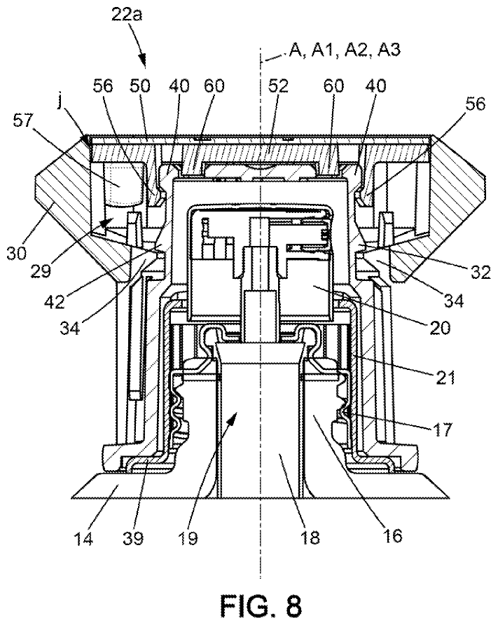

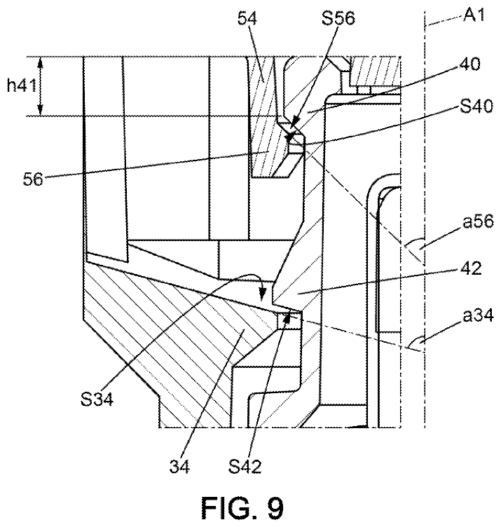

As is more particularly visible in FIGS. 8 and 9, shroud 30 has protruding reliefs 34 into internal cavity 26. Here, protruding reliefs 34 are located substantially at the boundary between lower and upper parts 26a of internal cavity 26. Protruding reliefs 34 extend substantially perpendicularly to the direction of axis A1 of cap 22a. Here, protruding reliefs 34 extend substantially in a radial direction relative to axis A1 of cap 22a.

As can be seen in FIG. 9 in particular, in a section plane comprising axis A1 of cap 22a, an upper surface S34 of each relief 34 forms a substantially right angle a34 with axis A1 of cap 22a. For example, angle a34 between surface S34 of each relief 34 and axis A1 of the cap is greater than or equal to 60°, preferably greater than or equal to 70°, and/or less than or equal to 120°, preferably less than or equal to 110°. Here, angle a34 is equal to 75°. As indicated above, angle a34 can be obtuse.

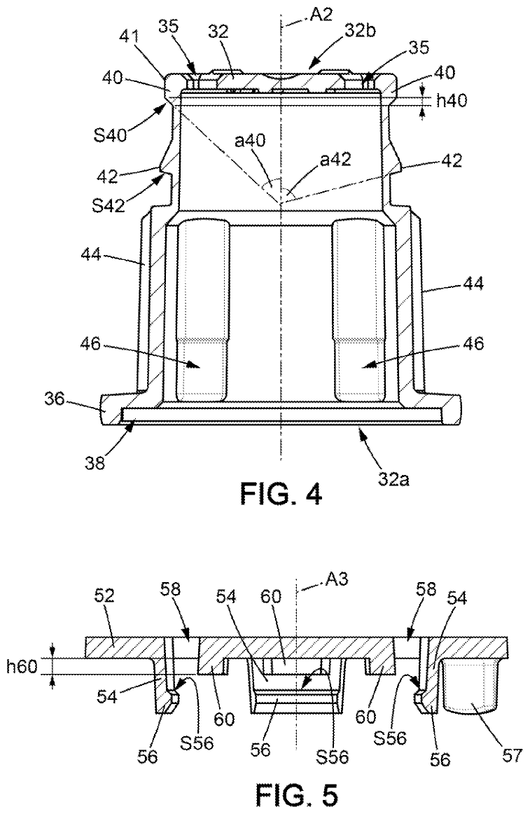

Furthermore, as can be seen in particular in FIGS. 3 and 4, insert 32 has the general shape of a sleeve. In other words, insert 32 has a general shape that is substantially cylindrical and hollow, with axis A2 corresponding to axis A1 of cap 22a when insert 32 is fixed in cap 22a. A first end 32a of insert 32 is empty or hollow. A second end 32b, opposite to first end 32a, is mostly solid. Here, second end 32b is a solid face comprising four through-openings 35 in the solid face. The four openings 35 here have the form of angular sections of a same ring, the axis being axis A2 of insert 32. The four openings 35 here are regularly distributed around axis A2 of insert 32.

Insert 32 has a flange 36 at its first end 32a. Flange 36 here forms a housing 38 suitable for covering a flange 39 of covering skirt 21 for ferrule 17. In one embodiment, flange 36 can be magnetized to ensure that cap 22a is fixed on neck 16 of bottle 12a. Here, however, the fixing of cap 22a on bottle 12a is achieved by the friction of insert 32 on covering skirt 21 for ferrule 17. Longitudinal flat areas 46 may be provided on the inner face of insert 32 in order to adjust the friction between insert 32 and covering skirt 21 for ferrule 17.

Alternatively, cap 22a can be fixed to bottle 12a by screwing or snap-fitting, in particular by snap-fitting, in particular clipping.

Furthermore, insert 32 forms snap-fit reliefs 40 on the substantially cylindrical surface of insert 32. Here, snap-fit reliefs 40 take the form of beads, arranged longitudinally at or near second end 32b of insert 32. Insert 32 as illustrated comprises four such snap-fit reliefs 40. However, insert 32 may comprise more or fewer snap-fit reliefs 40, in particular at least one snap-fit relief 40 or at least two snap-fit reliefs 40, preferably at least three snap-fit reliefs 40. Snap-fit reliefs 40 are preferably regularly distributed angularly around axis A2 of insert 32.

As is particularly visible in FIG. 4, each snap-fit relief 40 here has a lower surface S40, oriented towards the first end of insert 32, forming an angle a40 with axis A2 of insert 32 that is not a straight angle nor a right angle. For example, in a section plane of insert 32 comprising axis A2 of insert 32 illustrated in FIG. 4, angle a40 between lower surface S40 of a bead 40 and axis A2 is greater than or equal to 30°, preferably greater than or equal to 40°, and/or less than or equal to 60°, preferably less than or equal to 50°. Here, for example, angle a40 is substantially equal to 45°. As indicated above, angle a40 is preferably acute.

Each surface S40 also has a height h40 measured in the direction of axis A2 of insert 32.

Insert 32 also has a surface 41, connecting the upper end of surfaces S40 to second longitudinal end 32b of insert 32, which is cylindrical with a circular or even slightly tapering cross-section, so that the diameter of surface 41 decreases from the upper end of surfaces S40 towards second longitudinal end 32b of insert 32. In a longitudinal section plane, comprising axis A2 of insert 32, the angle between surface 41 and axis A2 is thus for example greater than 0°, and/or less than or equal to 10°, preferably less than or equal to 5°. Alternatively, the axis of surface 41 is axis A2 of insert 32. The upper end of surface 41 can be rounded, when viewed in a section view.

Insert 32 also forms lugs 42 on the radially outer face. Insert 32 as illustrated comprises four such lugs 42. Insert 32 may however comprise more or fewer lugs 42, in particular at least one or two lugs 42, preferably at least three lugs 42. Lugs 42 are preferably regularly distributed angularly around axis A1 of cap 22a.

Each lug 42 projects radially outward from the cylindrical portion of insert 32. Each lug 42 has a shape which primarily extends circumferentially over the cylindrical portion of insert 32.

As can be seen in particular in FIG. 4, each lug 42 here has a triangular cross-section, of which the lower surface S42 forms a substantially right angle with axis A2 of insert 32. For example, in a section plane of insert 32 comprising axis A2 of insert 32, angle a42 between lower surface S42 and axis A2 of insert 32 is greater than or equal to 60°, preferably greater than or equal at 70°, and/or less than or equal to 120°, preferably less than or equal to 110°. Angle a42 of surface S42 is preferably substantially equal to angle a34 of upper surface S34 of each relief 34 of shroud 30. Here, angle a42 is equal to 75°. As indicated above, angle a42 can be obtuse.

Finally, here insert 32 has longitudinal ribs 44 on its cylindrical portion, extending longitudinally over only a portion of the radially outer surface of insert 32. More specifically, insert 32 has pairs of such longitudinal ribs 44. In particular, in the illustrated example, insert 32 has four pairs of longitudinal ribs 44, regularly distributed over the radially outer surface of the cylindrical portion of insert 32.

It is noteworthy that an opening 35 and a bead 40 are aligned along the direction of axis A2 of insert 32. Similarly, a lug 42 and a pair of longitudinal ribs 44 are here aligned along the direction of axis A2 of insert 32. According to the particular embodiment shown in the figures, an opening 35, a bead 40, a lug 42, and a pair of longitudinal ribs 44 are aligned along the direction of axis A2 of insert 32.

As can be seen in particular in FIG. 8, here shroud 30 is fixed to insert 32 by protruding reliefs 34 of shroud 30 snap-fitting with lugs 42 of insert 32. To achieve this, insert 32 is inserted into shroud 30, this insertion being guided by longitudinal ribs 44 of insert 32 being received in complementary grooves 47 in shroud 30. The position of insert 32 is thus indexed relative to shroud 30. In other words, insert 32 can only be inserted into shroud 30 in a finite and restricted number of relative angular positions. Here, these relative angular positions are four in number. Insert 32 is then pushed into shroud 30 until protruding reliefs 34 of shroud 30 snap-fit with lugs 42 of insert 32.

It should be noted here that due to the substantially right angles a34, a42 between the surfaces S34, S42 of protruding reliefs 34 and of lugs 42, which cooperate to ensure the fixing of insert 32 in shroud 30, and the direction of insertion of insert 32 into shroud 30, which is parallel to axis A1 of cap 22a, the snap-fitting of insert 32 in shroud 30 is permanent. In other words, it is very difficult or even impossible to remove insert 32 from shroud 30 without damaging one of these two parts, in particular the projecting reliefs 34 of shroud 30 and/or the lugs 42 of insert 32. This disassembly of insert 32 from shroud 30 is made all the more difficult by the relatively high rigidity of protruding reliefs 34 and lugs 42, if only due to their shape.

The fixing of insert 32 in shroud 30 by snap-fitting appears to be durable and particularly easy to achieve, requiring no additional parts.

Of course, insert 32 can be fixed in shroud 30 by means other than snap-fitting. In particular, insert 32 can be glued into shroud 30. Additionally or alternatively, insert 32 can be inserted by force into shroud 30 and be held there by friction.

In the following, decorative part 28 is described in more detail.

As can be seen in FIGS. 2 and 3, decorative part 28 comprises a face F28 facing outwardly from cap 22a, provided with a decoration 48.

Decoration 48 of decorative part 28 can in particular be chosen among:
a color, in particular other than the color of hollow body 24, notably of shroud 30,
a pattern, in particular imitating a material,
at least one disc made of a material or imitating the appearance of a material,
a commercial brand, in particular a logo,
a recessed or projecting relief.

As is particularly visible in FIG. 3, the illustrated decorative part 28 consists of a decorative plate 50, forming face F28 provided with decoration 48, and a support plate 52. The implementation of decorative part 28 as at least two separate pieces is preferred because this allows greater variety in decorative plates 50, the function of these plates being solely aesthetic. In particular, the decorative plate can be made of a greater variety of materials in this case. Support plate 52 then fixes decorative part 28 to insert 32 as will be described in more detail below.

Here, decorative plate 50 is flat.

Decorative plate 50 is fixed to support plate 52. For example, decorative plate 50 is glued to support plate 52. Other means of fixing decorative plate 50 to support plate 52 are possible, however. For example, decorative plate 50 can be tightly mounted within a frame formed by support plate 52.

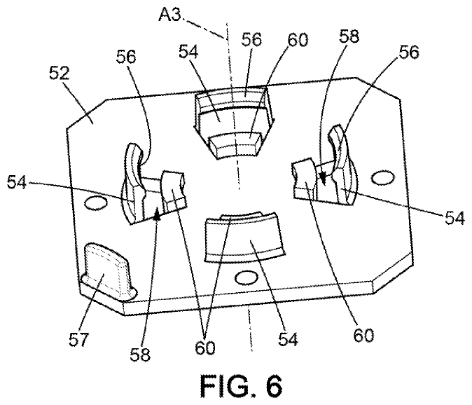

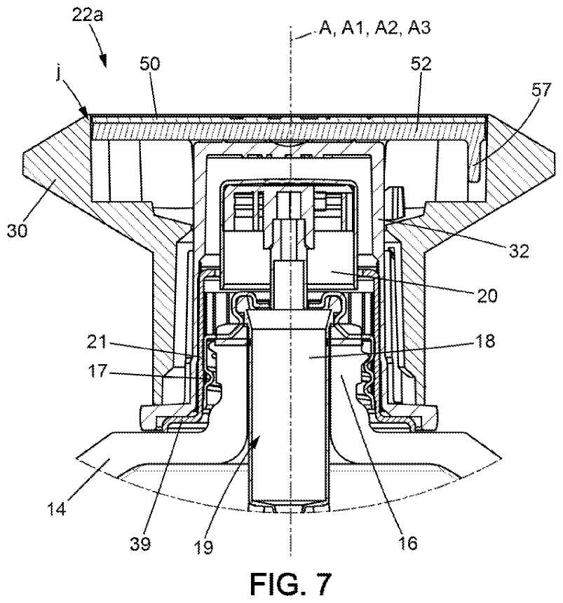

Support plate 52 is illustrated in particular in FIGS. 5 and 6.

As can be seen in these figures, support plate 52 extends essentially perpendicularly to an axis A3 which is the center line of support plate 52, intended to correspond to axis A1 of cap 22a when decorative part 28 is fixed in cap 22a.

Support plate 52 has a substantially flat face, on which decorative plate 50 is intended to be fixed.

Support plate 52 also comprises tabs 54 whose free end has the shape of a hook 56. For example, in a section plane of support plate 52 comprising axis A3 normal to support plate 52, angle a56 between upper surface S56 of hooks 56 and axis A3 normal to support plate 52 is greater than or equal to 30°, preferably greater than or equal to 40°, and/or less than or equal to 60°, preferably less than or equal to 50°. Preferably, angle a56 of upper surface S56 is equal to angle a40 between lower surface S40 of a bead 40 of insert 32 and axis A2 of insert 32. Here, for example, angle a56 is substantially equal to 45°. As indicated above, angle a56 is preferably acute.

Support plate 52 also comprises a tongue 57. Tongue 57 here extends at an angle to support plate 52. Tongue 57 extends along a main direction of extension parallel to axis A3 normal to support plate 52. Here, tongue 57 is substantially parallelepipedal.

Support plate 52 further comprises through-holes 58. Here, there are four through-holes 58. Each through-hole 58 has the general shape of an angular sector of a same ring. Through-holes 58 are regularly distributed angularly around axis A3 normal to support plate 52. Through-holes 58 are equidistant from the center of support plate 52. Through-holes 58 can in particular allow the discharge of excess adhesive from between support plate 52 and decorative plate 50 and/or facilitate the molding of support plate 52, in particular the molding of the tabs 54 described below. Concerning the excess glue between support plate 52 and decorative plate 50, at least one of these plates 50, 52, in particular support plate 52, can comprise recesses which allow receiving at least some of the excess glue.

Flanges protrude from support plate 52, on its face opposite to its face intended to receive decorative plate 50, from the radially inner edge of through-holes 58, each flange thus forming a ridge 60. Ridges 60 have for example a height h60, measured in the direction of axis A3 normal to support plate 52 from the support plate 52 surface from which they project, substantially equal to the height of openings 35 in insert 32. Thus, ridges 60 are suitable for being received in openings 35 so as to partially close them off, without extending beyond openings 35.

As is particularly visible in FIGS. 8 and 9, decorative part 28 is fixed to insert 32 by snap-fitting of hooks 56 of tabs 54 of support plate 52 with the first snap-fit reliefs 34 in the form of beads, of insert 32. Tongue 57 of support plate 52 can be received in a complementary housing 29 of shroud 30, to guide insertion of decorative part 28 along a straight path within inner cavity 26 defined by shroud 30.

Once decorative part 28 is fixed to insert 32, ridges 60 of support plate 52 extend inside openings 35 of insert 32. However, ridges 60 do not protrude beyond openings 35 of insert 32 in the direction of first end 32a of insert 32.

Furthermore, as can be seen in FIGS. 8 and 9 in particular, once decorative part 28 is fixed to insert 32, said part is entirely received within internal cavity 26 of shroud 30. In other words, the surface forming face F28 of decorative part 28 is preferably flush with or even slightly recessed relative to the upper end of shroud 30. This thus prevents the removal or attempted removal of the decorative part by grasping a portion of an edge of decorative part 28 protruding from shroud 30 in the direction of axis A1 of cap 22a.

Also, decorative part 28 fixed to insert 32 extends into internal cavity 26 of shroud 30 with reduced clearance j. For example, clearance j between decorative part 28 and the walls defining internal cavity 26 of shroud 30, at the upper end of cap 22a, is for example less than or equal to 1 mm, preferably less than or equal to 0.5 mm, more preferably less than or equal to 0.2 mm. It is thus difficult or even impossible to insert a rigid element into the gap between decorative part 28 and shroud 30 to achieve leverage in an attempt to remove decorative part 28 from cap 22a.

However, due to the angles a40, a56 formed by surfaces S40, S56 of beads 40 and of hooks 56, which are relatively slightly inclined with respect to the direction of axis A1 of cap 22a, the snap-fitting of decorative part 28 on lug 42 can be disassembled without damaging the component parts of cap 22a, in particular without damaging decorative part 28, shroud 30, or insert 42. This disassembly is facilitated by the relative flexibility of tabs 54. Thus, beads 40 and tabs 54 are for example shaped to allow disassembling decorative part 28 from hollow body 24, by pushing one among decorative part 28 and hollow body 24 relative to the other, in the direction of axis A1 of cap 22a. In this case, the force exerted, parallel to axis A1 of cap 22a, causes resilient deformation of tabs 54, the surface S56 of hooks 56 following the ramp formed by surface S40 of bead 40, until snap-fit surfaces S40, S56 are no longer facing each other at all. The push force necessary for this disassembly is for example greater than or equal to 10 N, preferably greater than or equal to 15 N, and/or less than or equal to 50 N, preferably less than or equal to 30 N. This reduces the chances of damaging a component part of cap 22a. The push force is, according to one particular example, substantially equal to 20 N.

It should be noted that from the position in which surfaces S40, S56 are no longer facing each other at all, the movement of removing decorative part 28 can continue, hooks 56 following tapered surface 41 at the top of insert 32, because tabs 54 tend to return to a position substantially parallel to axis A2 of insert 32.

However, due to the configuration of cap 22a, access to decorative part 28 in order to exert such a push force is relatively difficult. In particular, it is not possible to exert such a force on decorative part 28 by inserting a finger into cap 22a. This reduces the risk of an unexpected disassembly of decorative part 28.

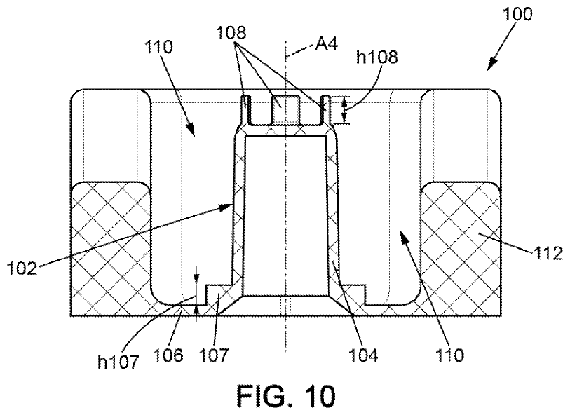

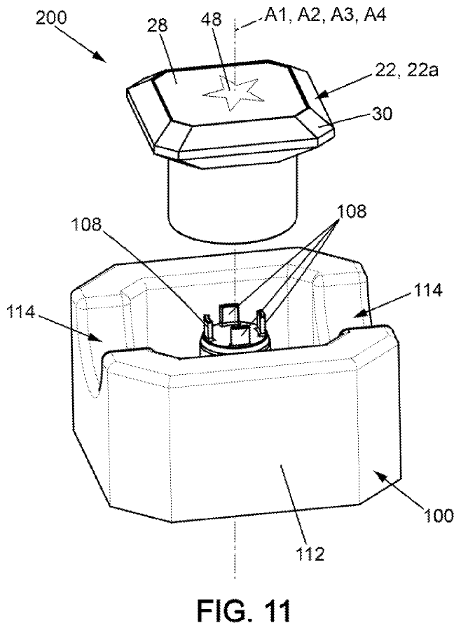

It is proposed here to make use of a tool 100, illustrated in FIGS. 10 and 11, to remove decorative part 28 from hollow body 24, in particular when the user wishes to change decorative part 28. FIG. 11 illustrates the assembly 200 formed by such a tool 100 and the associated cap 22a.

Tool 100 as illustrated comprises a relief 102 suitable for being received in hollow body 24 of cap 22a, in particular in insert 32 so as to be in contact with decorative part 28. Here, relief 102 takes the form of a cylindrical rod 104 projecting from a base 106 in the direction of an axis A4 intended to correspond to axis A1 of cap 22a when the latter is received on tool 100. Cylindrical rod 104 is for example hollow, in order to facilitate production by molding. Cylindrical rod 104 has tabs 108 at its free end, that are shaped to be received in openings 35 in insert 32 and to come into contact with ridges 60 of support plate 52 of decorative part 28, when cap 22a is received on tool 100. To allow such receiving, tool 100 forms a housing 110 around cylindrical rod 104, shaped to receive cap 22a. Housing 110 is delimited on the outside by walls 112. Walls 112 can in particular allow guiding the relative movement of cap 22a with respect to tool 100. Here, two of the opposing walls 112 have, at their top, a recess 114 facilitating the removal of hollow body 24 when decorative part 28 has been removed, as will be described below. Alternatively, a single wall 112 may have such a recess 114, or more than two walls 112. In particular, each wall 112 may have such a recess 114.

Base 106 of tool 100 also has a pedestal 107, at the foot of relief 102. The cross-section of pedestal 107 is complementary to housing 38 at end 32a of insert 32. However, pedestal 107 has a height h107, measured along axis A4 of the tool, greater than or equal to the height of housing 38 at end 32a of insert 32, measured along the direction of axis A2.

Tool 100 is for example made of plastic. The tool is preferably of a material having a lower hardness than the material with which cap 28 is made and/or a soft material to avoid damage to cap 28 when tool 100 is used. It is also possible for the edges of tool 100 to be rounded or chamfered.

It is easy to use tool 100.

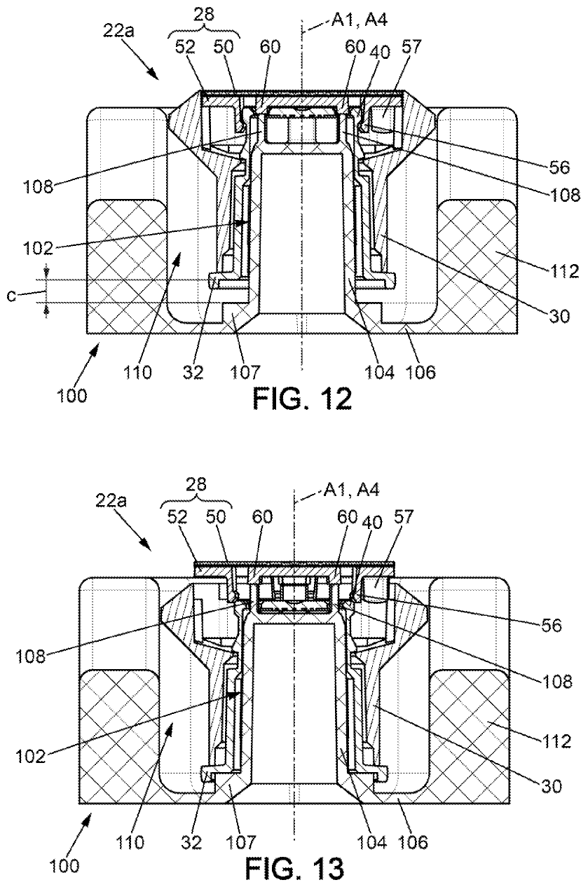

Firstly, as illustrated in FIG. 12, cap 22a is set in place on tool 100, so that tabs 108 of tool 100 are in contact with ridges 60 of support plate 52. Tabs 108 of tool 100 can then extend at least partially through openings 35 in insert 32.

The positioning of cap 22a on tool 100 can be facilitated by walls 112 defining housing 110, these walls 112 making it possible to guide cap 22a on cylindrical rod 104. Housing 110 here thus has a cross-section complementary to the cross-section of the upper part of shroud 30, rotationally symmetrical around axis A1. One will note here that the positioning is also facilitated by the fact that cap 22a is rotationally symmetrical around its axis A1, so that the four positions enabling cap 22a to be received on tool 100, in particular in housing 110, all lead to the same configuration. Conversely, a cap 28 that is fully rotationally symmetrical appears less favorable to easy positioning of cap 22a on tool 100. It is indeed possible for the tabs 108 of the tool 100 not to be directly facing ridges 60 of support plate 52 and a relative rotation of cap 22a with respect to tool 100 is then necessary, with no visual cue to facilitate such positioning by relative rotation.

Particularly in the latter case, a means of angular indexing of cap 22a in tool 100 may be provided, making it possible to ensure that cap 22a is correctly placed on tool 100 so that a push force on cap 22a towards tool 100 indeed enables decoration part 28 to be removed.

Secondly, cap 22a is inserted further into housing 110 of tool 100. In other words, cap 28 is pushed in the direction of axis A1 of cap 22a, in the direction of tool 100. This push is guided by walls 112 of housing 110. This push results in tabs 108 pushing against ridges 60 of holes 58 of support plate 52. Due to the relatively large inclination of surfaces S40, S56 of reliefs 40, 56 enabling the attachment of decorative part 28 onto insert 32 and/or due to the resilience of these reliefs, in particular of tabs 54 carrying hooks 56, it is then possible to “un-snap-fit” the reliefs 56, 40 and remove decorative part 28 from cap 22a, without damaging decorative part 28, shroud 30, or insert 32.

Height h108 of tabs 108 added to height h60 of ridges 60, when there are such, can be at least greater than or equal to height h40 of beads 40. Preferably, height h108 of tabs 108 added to height h60 of ridges 60, when there are such, is preferably greater than or equal to height h40 of beads 40 when added to height h41 of surface 41 connecting upper end of surfaces S40 to second longitudinal end 32b of insert 32. in other words, height h108 of tabs 108 added to height h60 of ridges 60, when there are such, is preferably greater than or equal to the distance, measured in the direction of axis A2 of the insert, between the lower (or free) end of surface S56 of hooks 56 and the second end 32b of insert 32.

Preferably, the push on cap 28 is possible over a path c whose length, measured in the direction of axis A4 of tool 100, is at least greater than or equal to height h40 of beads 40. Preferably, path c has a length greater than or equal to height h40 of beads 40 plus height h41 of surface 41 connecting the upper end of surfaces S40 to second longitudinal end 32b of insert 32. In other words, path c is preferably greater than or equal to the distance, measured along the direction of axis A2 of the insert, between the lower (or free) end of surface S56 of hooks 56 and the second end 32b of insert 32.

Path c is slightly less than or equal to height h108 of tabs 108, to prevent the bottom of insert 32 from abutting against the upper end of cylindrical rod 104 before the insert abuts against pedestal 107.

Decorative part 28 when removed can then be kept, in particular for later reassembly on cap 22a of bottle 12a or possibly on another cover 22 suitable for another casing 12. A new decorative part 28 can then be placed in cap 22a, replacing the removed decorative part 28. This placement is carried out by snap-fitting, in principle without requiring the use of any tool.

This disclosure is not limited to the embodiments described above solely by way of examples, but encompasses all variants conceivable to those skilled in the art within the framework of the protection sought. In particular, the various examples described above can be combined as long as their teachings are not contradictory.

For example, in the example described above, the packaging device for a cosmetic product is a perfume bottle fitted with a pump. The bottle may, however, be without such a pump.

The attachment of a decorative part as just described can also be carried out on a cap of a packaging device for the application of a cosmetic product for the lips, in particular for a lipstick. The cap then presents such a decorative part. The cap can be fixed to a lipstick body comprising a lipstick mechanism.

It is also possible to implement a cap as described above, in a device for packaging and applying a liquid cosmetic product, in particular a mascara or a gloss. In this case, the cap can be integral with an applicator member for liquid cosmetic product. For example, a rod connects the cap to the applicator member for cosmetic product. The rod can be fixed to or made of the same material as the insert in the cap. In this case, the free end of the cylindrical rod of tool 100 advantageously has a hole allowing the passage of the rod and applicator member when the cap is placed on the tool.

Moreover, in the example shown, tool 100 does not cooperate with the snap-fit reliefs of the decorative part, but pushes on the decorative part. Indeed, the snap-fit reliefs of the decorative part are not accessible from inside the insert. These snap-fit reliefs are thus invisible to a user, which contributes to the aesthetic appearance of cap 22a. However, alternatively, the snap-fit reliefs of the decorative part are fixed to the insert, so as to be accessible from inside the insert. For example, the snap fit reliefs of the decorative part can take the form of tabs traversing the openings in the insert and can each be fixed to a rim of one of these openings. In this case, the tabs of tool 100 can cooperate directly with these snap-fit reliefs. This reduces the force to be applied to the decorative part in order to disassemble it, by pushing directly on the snap-fit tabs, which will then deform resiliently while following the complementary snap-fit reliefs. The risk of damaging one of the parts of the cap is therefore further reduced, during disassembly of a decorative part.

Also, according to another variant, the snap-fit reliefs of the decorative part cooperate with complementary snap-fit formed by the cap.

The claims are as follows:

1. A cover for a packaging device for at least one cosmetic product, the cover being suitable for attachment on a packaging casing for a cosmetic product, the cover comprising:
a hollow body extending primarily in a longitudinal direction, comprising a first longitudinal end defining a first opening and intended to be oriented towards the casing of the packaging device, and a second longitudinal end defining an opening, opposite to the first longitudinal end, the hollow body comprising at least one first snap-fit relief, and
a decorative part, the decorative part comprising at least one face intended to be oriented in a direction opposite to the packaging casing and having a decoration, and at least one second snap-fit relief,
the decorative part being fixed to the hollow body so as to close off the second opening of the hollow body, by snap-fitting of the at least one first and at least one second snap-fit reliefs, it being possible to disassemble the snap-fitting of the at least one first and at least one second snap-fit reliefs without damaging the hollow body nor the decorative part.

2. The cover according to claim 1, wherein the hollow body comprises a shroud defining an internal cavity, and an insert fixed inside the shroud.

3. The cover according to claim 2, wherein the insert has the general shape of a sleeve extending in the longitudinal direction between a first longitudinal end of the insert and a second longitudinal end of the insert, the first longitudinal end of the insert being intended to be oriented towards the first longitudinal end of the hollow body.

4. The cover according to claim 2, wherein the shroud is fixed to the insert by snap-fit of at least one third snap-fit relief of the shroud with at least one fourth snap-fit relief of the insert, the at least one third snap-fit relief being on an inner face of the shroud.

5. The cover according to claim 2, wherein the insert has a means for fixing the cover to the casing of the packaging device.

6. The cover according to claim 2, wherein the at least one first snap-fit relief is formed by the shroud.

7. The cover according to claim 2, wherein the at least one first snap-fit relief is formed by the insert.

8. The cover according to claim 7, wherein the at least one first snap-fit relief is formed on an outer face of the insert.

9. The cover according to claim 6, wherein the at least one first snap-fit relief is formed by at least one bead, the at least one second snap-fit relief being formed by at least one resiliently deformable tab extending from a face of the decorative part that is opposite to the at least one face having a decoration.

10. The cover according to claim 1, wherein the at least one face having a decoration, of the decorative part, is substantially planar.

11. The cover according to claim 1, wherein the at least one face having a decoration, of the decorative part, is flush with the second end of the hollow body.

12. The cover according to claim 1, wherein the decorative part comprises a decorative plate and a support plate for the decorative plate, the decorative plate being fixed, in particular glued, to the support plate.

13. The cover according to claim 1, comprising a clearance between the decorative part and the second end of the hollow body.

14. The cover according to claim 1, wherein each first snap-fit relief comprises a first surface in contact with a second surface of an associated second snap-fit relief, each first or second surface extending in a plane which forms an angle with the longitudinal direction.

15. The cover according to claim 1, wherein the at least one first snap-fit relief and the at least one second snap-fit relief are shaped to allow disassembly of the decorative part from the hollow body, by pushing on one among the decorative part and the hollow body in the longitudinal direction.

16. The cover according to claim 1, wherein the decoration comprises at least one among:
a pattern,
at least one disc made of a material or imitating the appearance of a material,
a trademark, or a logo, and
a recessed or protruding relief.

17. The cover according to claim 1, wherein the cover is a cap.

18. The cover according to claim 17, wherein the hollow body is integral with a rod, an applicator member being arranged at the end of the rod that is opposite to the hollow body.

19. A packaging device for at least one cosmetic product, comprising a casing defining a volume for receiving at least one cosmetic product, and a cover according to claim 1, fixed on the casing.

20. The packaging device according to claim 19, wherein the casing is a bottle with a neck, the cover being a cap suitable for fixing to the neck of the bottle.

21. The packaging device according to claim 19, wherein the casing is a lipstick body, receiving a lipstick mechanism.

22. A tool for removing a decorative part of a cover according to claim 1, from the hollow body of the cover, the tool comprising a relief suitable for being received in the hollow body of the cover so as to be in contact with a face of the decorative part, opposite to the at least one face having a decoration, and to allow a push force to be applied on the decorative part.

23. The tool according to claim 22, further comprising a housing for receiving the cover, the relief of the tool projecting from a bottom of the housing.

24. The tool according to claim 22, wherein the hollow body of the cover comprises a shroud defining an internal cavity, and an insert fixed inside the shroud, and wherein the insert has the general shape of a sleeve extending in the longitudinal direction between a first longitudinal end of the insert and a second longitudinal end of the insert, the first longitudinal end of the insert being intended to be oriented towards the first longitudinal end of the hollow body or forming the first longitudinal end of the hollow body, the second longitudinal end of the insert being solid with at least one through-opening in the longitudinal direction, wherein the relief extends in a longitudinal direction, a longitudinal end of the relief of the tool presenting at least one tab having a position and dimensions suitable for coming into contact with the face of the decorative part that is opposite to the at least one face having a decoration, through the at least one through-opening in the insert and to allow a push force to be exerted on the face of the decorative part that is opposite to the at least one face having a decoration, as long as the hollow body of the cover is not in contact with the bottom of the housing, when there is such.

25. The tool according to claim 24, wherein the height of the tabs, measured in the longitudinal direction, is such that the tabs push on the decorative part over a relative travel of the hollow body with respect to the tool that is at least equal to the height of the first snap-fit reliefs.

26. The tool according to claim 24, wherein the relief of the tool has a cylindrical rod suitable for traversing all or part of the hollow body of the cover.

27. The tool according to claim 22, wherein the tool is shaped to allow positioning the cover on the tool in a finite number of angular positions.

28. A method for removing a decorative part from a cover according to claim 1, by means of a tool according to claim 22, the method comprising the steps of:
placing the cover in position on the tool;
exerting a relative push force on the cover in the direction of the tool, along the longitudinal direction.
